(19) United States
(12) Patent Application Publication
(10) Pub. No.: US 2006/0271844 A1
(43) Pub. Date: Nov. 30, 2006

(54) Thin client method and system for generating page delivery language output from applets, views, and screen definitions

(75) Inventors: Atul Suklikar, San Mateo, CA (US); Salman Malik, San Francisco, CA (US)

Correspondence Address: CSA LLP, 4807 SPICEWOOD SPRINGS RD., BLDG. 4, SUITE 201, AUSTIN, TX, 78759, US

(73) Assignee: Siebel Systems, Inc.

(21) Appl. No.: 11/415,406

(22) Filed: May 1, 2006

Related U.S. Application Data
(63) Continuation of application No. 09/540,303, filed on Mar. 31, 2000, now abandoned.

(51) Int. Cl. G06F 17/00

(52) U.S. Cl. 715/513; 715/530

(57) ABSTRACT

the local computer to transfer data between the local computer and the remote computer. Platform independent language pages are displayed on the thin clients. The platform independent page delivery language output is produced by server resident applications that use templates from applets, views, and screen definitions.

### TECHNICAL FIELD

The invention relates to client-server systems, and especially network centric, thin client type systems where a local computer provides a user interface and performs local input/output to interact with at least one remote computer which implements data processing (e.g., data management, data sharing) in response to the local computer to transfer data between the local computer and the remote computer. More particularly, the invention relates to generating page delivery language output templates from applets, views, and screen definitions. The method and system of the invention are especially useful where one or more interconnected networks link the computers.

### BACKGROUND

“Thin-client” is a client server paradigm where the “thin client” provides a user interface, accepting keystrokes and mouse clicks for transmission to the server, processing the user input at the server, using application software resident on (or accessed by) the server, and returned to the user in the form of a platform independent file, for example, an HTML file. Processing and data remain on the server. Stripped to its essentials, the thin client paradigm is:

1. The “thin client” is a user terminal, accepting user inputs, providing user output, and hosting neither applications nor data nor processing.

2. The applications, data storage, data processing, and telecommunications reside on the server.

This is accomplished through the use of a multi-user operating system such as Windows NT, OS/2, Unix, or Linux, with terminal server middleware, such as Citrix Metaframe. The thin client can be a web browser.

One challenge in developing “thin client” applications is to properly configure the page delivery language output (as pushbuttons, choice boxes, toolbars, status bars, progress bars, bitmaps, icons, sliders, tabs, views, forms, tables, and the like) that is sent from the server to the client. Specifically, configuring HTML Thin Client Applications (HTML Applications) typically involves reimplementing an HTML-specific user interface through hand-crafted HTML code, that is separate from the traditional client interface.

This process is tedious, is error prone, takes a long time, includes duplicated effort, and is performed largely outside the server environment. Any new configuration process must address these shortcomings.

Unlike the other deployments of server side thin client-server applications, an HTML Application exists within the context of the Server-side Application (HTML Application) at the customer's overall website. It is important for the HTML Application to be able to take on the look and feel of this website. As a result, it is critical for the configuration process to enable developers to create the right look and feel using the full power of HTML rather than being constrained by an approach that generates HTML from alternate UI representations. Server-side customers may have preferred HTML development tool that they use to build and configure the rest of their website. The people responsible for the website development will also be involved with the configuration of the look and feel of the vendored application. It is therefore necessary for the configuration process to support a dual development environment in which developers can configure the HTML Application in kits included with the vendored server-side application as well as the external HTML development tools of choice.

### SUMMARY

The invention relates to a thin client client-server system and method, where the system includes a server for a thin client client-server system. The system is configured to define models and to build and configure display objects in a page delivery language based on the models. The display objects are then assembled into a page delivery language application. The models to be defined are pages, and the page delivery language can be any page delivery language, for example, HTML, XML, DHTML, and WML. The display objects are applets and views. The display objects are most frequently assembled from templates. With respect to templates, the system and method facilitate editing the display object templates. A further aspect of the invention is the logical separation of style sheets and templates from display objects. This separation of the Logical User Interface (Applets, Views, Screens) from the physical presentation (Templates) is a hallmark of the architecture. A further aspect of the invention is the reuse of style sheets and templates across display objects.

One aspect of the method and system of the invention is a method of and a system for defining the business object model (page views or frames) by building and configuring HTML display objects (applets/views), assembling HTML display objects into an HTML application) and upgrading the server side application, for example, to store the page views, frames, applets, and views in a suitable repository.

A further aspect of the method and system of the invention is that the system is configured to build and configure HTML business objects using, for example, a method comprising the steps of editing a template, editing an applet, and generating an HTML application from the template and applets.

A still further aspect of the method and system of the invention is creating an applet by editing a template and compiling the template containing the edited applet.

Still another aspect of the method and system of the invention is assembling the HTML objects into an HTML application by editing the proper template or templates, editing the constituent applets and views of the template, and validating the resulting HTML application.

The method and system may be to upgrade an installed HTML application by: applying the above upgrades and thereafter adjusting the upgrades.

Upgrading pages, views, and applets may be done through one or more of an HTML editor, ActiveX controls, or configuring Java Beans.

While the invention has been described with respect to HTML, it is to be understood that the method and system of the invention may be used with XML, DHTML, WML, and other platform independent page delivery languages.

### BRIEF DESCRIPTION OF THE DRAWINGS

The method and system of the invention are illustrated in the FIGURES appended hereto.

FIG. 1 illustrates a client server system having a “thin client” architecture and functionality, and is denominated “Prior Art.”

FIG. 2 illustrates the relationships between the various entries of an HTML application.

FIG. 3 illustrates the various objects in an HTML application.

FIG. 4 illustrates the steps in creating and configuring an applet.

FIG. 5 illustrates the steps in assembling an HTML application

FIG. 6 illustrates the various steps in the Upgrade Process.

### DETAILED DESCRIPTION

### A. OVERVIEW AND DEFINITIONS

The method and system described herein relate to network centric, thin client, client-server systems and methods, and especially such systems and methods enable rapid and easy configuration of page delivery language objects, and especially HTML display objects. The configuration process encompasses four tasks. First is defining the relevant business object model. The second task is building and configuring HTML display objects based on the business object model. Third is assembling the HTML display objects into an HTML Application. Fourth is the optional step of upgrading the configured HTML Application to later releases of the server software.

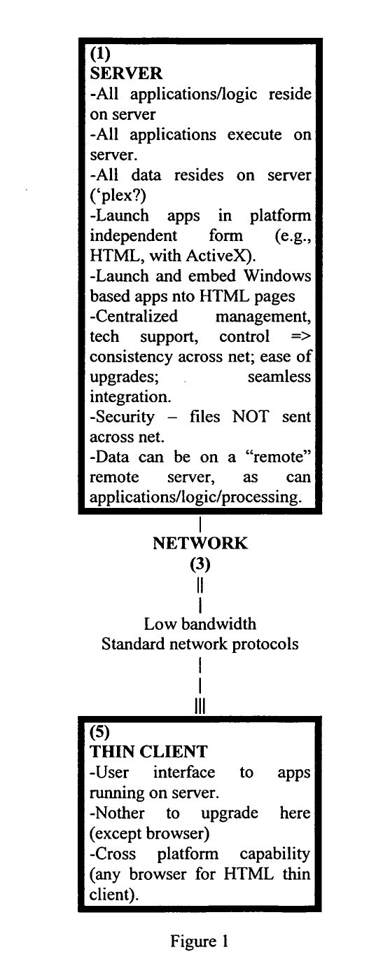

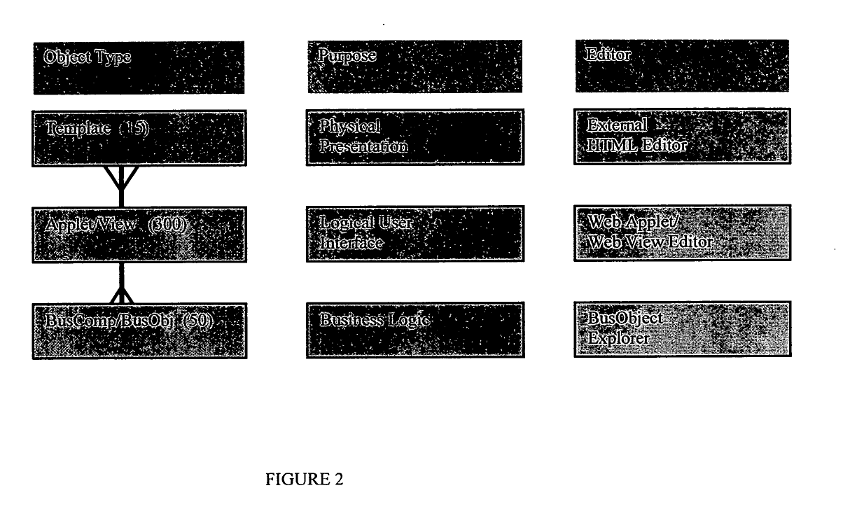

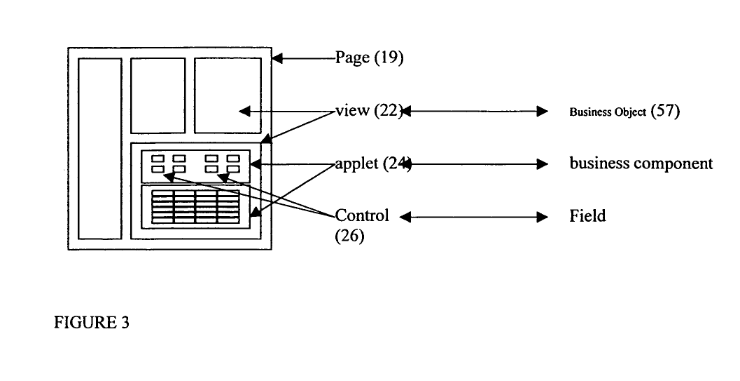

FIG. 1 illustrates a client server system having a “thin client” architecture and functionality, and is denominated “Prior Art.” FIG. 2 illustrates the relationships between the various entries of an HTML application. FIG. 3 illustrates the various objects in an HTML application.

FIG. 1 illustrates a generalized “thin client” client-server system of the Prior Art. To be noted is a server, 1, connected to a thin client, 5, through a network, 3, for example, a low bandwidth network. All applications/logic reside on the server, 1, and execute on server.

Additionally all of the data either resides on the server, 1, or is accessible through the server 1. The server, 1, launches applications in platform independent form (e.g., HTML, with ActiveX), and more particularly, the server, 1, launches applications and embeds Windows based applications into HTML pages. This type of “thin client” architecture provides centralized management, technical support, and control, leading to consistency across the network, 3; ease of upgrades; and seamless integration. Moreover, the “thin client” architecture and paradigm provides an added measure of security in that files are not sent across network, 3. Data can be on a “remote” remote server, 1, as can applications/logic/processing.

The network, 3, is characterized by low bandwidth, and standard network protocols.

The thin client, 5, provides a user interface to applications running on server, 1. There is no application software on the client, 5, to upgrade except the browser. This provides cross platform capability (any browser for HTML thin client).

FIG. 2 illustrates the relationship between the various entities in an HTML, application in accordance with the invention on the server, such as the templates, the applets and views, and the HTML display object. The numbers in parentheses represent the typical number of entities of that type that would be found in an HTML Application.

FIG. 3 shows the relationships and hierarchy of the elements of a page, 19, according to the invention, with a page, 19, being made up of views, 22. A view, 22, corresponds to a business object. The view, 22, is made up of applets, 24, which correspond to business components. An applet, 24, includes controls, 26, which correspond to fields.

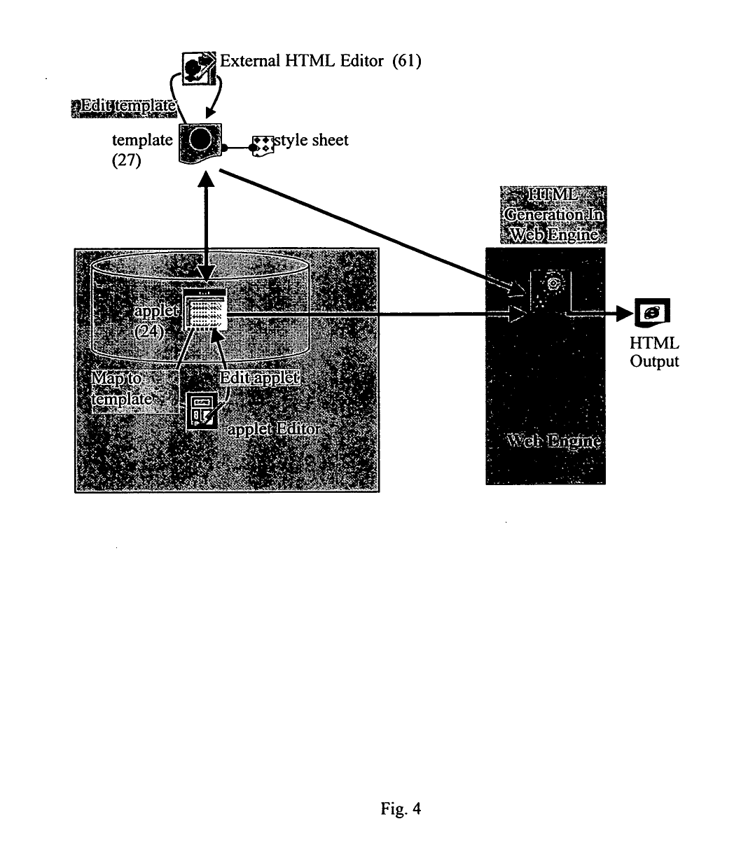

FIG. 4 illustrates editing a template, 27, and mapping an applet, 24, to the template, 27, and passing the edited applet, 24, through the web engine, 45, to generate an HTML document.

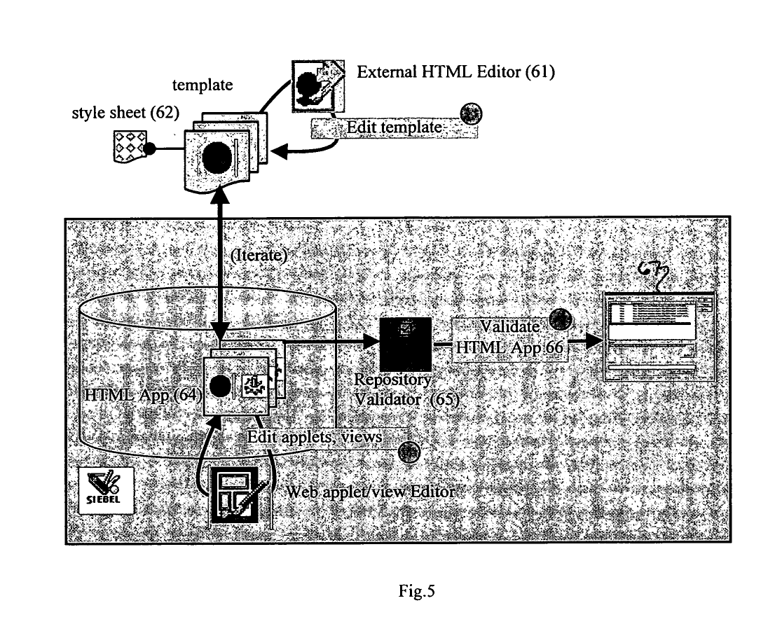

FIG. 5 illustrates the process of creating an HTML application, with an external HTML editor, 61, and a style sheet, 62, used to edit a template, 27, and form an HTML application, 64, which is validated in a repository validator, 65, and validated, 66, to yield a validated HTML application, 67.

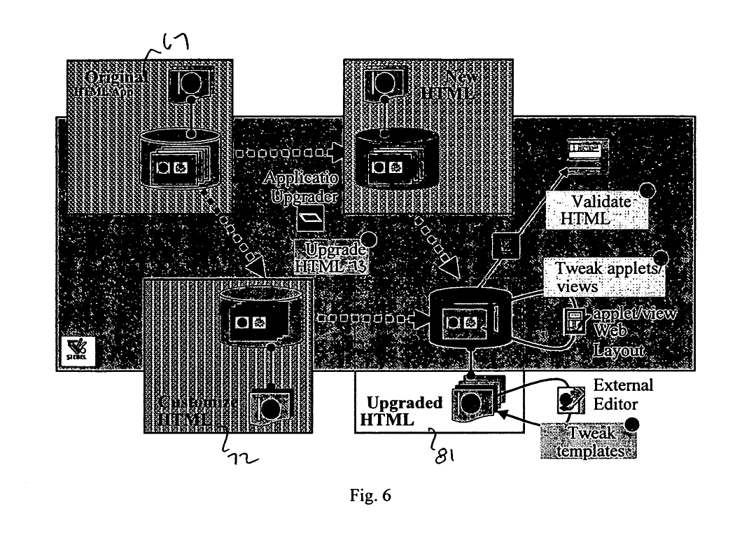

FIG. 6 illustrates the process of going from an original HTML application, 67, to an upgraded HTML application, 81. The original HTML application is customized, 72, and upgraded, 73, with validation, and viewing, to yield an upgraded HTML application, 81.

Turning now to the terminology of thin clients and browsers, the following terms are used with their following meanings, and are illustrated in FIG. 2 and FIG. 3.

Tags—Tags are vendor developed members of a library, each of which can be embedded within normal HTML files to give directives to the server, as a Siebel Web Engine, for creating the final HTML pages. In the case of a Siebel Web Engine, the types of Siebel Tags include Placeholders for Siebel Controls, 23, and applets, 24, viewbars, iterators, etc.

HTML display object—An HTML display object is a repository representation of an HTF. There is a one-to-one correspondence between HTF and an HTML display object. The HTML display object contains information about the various tags as Siebel Tags, that appear in the HTF as well as references to other HTML Files. The HTML display object is also referred to as the template object or Siebel template object in this document.

Template—A template, 27, is an HTML file containing both standard HTML and tags as Siebel tags, that is, a template, 27, is a model or style for generating an HTML display object. Information in the template, 27, is combined with information stored in the HTML display object, 26, definition in a repository to generate the final HTML output. An Application will have one or more templates, 27, that define the look of the various types of applets, 24, or views, 22, in the Application. The benefit of using templates, 27, is that updating the overall look and feel of the application can be easily accomplished by modifying just the templates, 27, rather than having to edit the definition of all the HSWE files as is required today.

HTML Application—An HTML application is a repository representation using the application object. It contains the definitions of the various applets, views, Web Pages etc. that make up the application. FIG. 2 shows the various elements of HTML applications, as the template, the applets and/or views, and the HTML display object file.

Applet Modes—An applet, 24, can be rendered used in up to three modes-Base, Edit and Query. The Base mode is a read-only rendering of the applet. Edit mode allows the editing of the currently selected record. Query mode allows the user to use Query By Example to query a business component. Different templates can be used by an applet for each mode. FIG. 3 shows applets, generally, as part of a page, with views, applets, and fields, where the views correspond to business objects, the applets correspond to business components, and the fields correspond to controls.

### B. DETAILED DESCRIPTION

The method and system described herein relate to network centric, thin client, 5, client-server systems and methods, and especially to such systems and methods that enable rapid and easy configuration of page delivery language objects, and especially HTML display objects. The configuration process encompasses four tasks. First is defining the relevant business object model, 57. The business component and business object models are shown in FIG. 3. Specifically, the business object model, business component, or business object, 57, is the underlying task of entering an order, preparing a bid or a quotation, preparing a product configuration, or the like. The second task is building and configuring HTML display objects, i.e., HTML applications, 67, based on the business object model. At a very high level, this is the HTML output shown in FIG. 4, the HTML output of FIG. 5, and the HTML Application of FIG. 5. Third is assembling the HTML display objects of FIGS. 4 and 5 into an HTML Application, 67. Fourth is the optional step of upgrading the configured HTML Application, 67, to later releases of the server software.

1. Defining the Business Object Model

The business object model, shown in FIGS. 3 and 5, including business objects, business components, etc. is defined using the current capabilities of web server toolkits, such as Siebel Tools.

Building and configuring HTML display objects, as shown in FIG. 3, with applets and controls, is based on the business object model. As shown in FIG. 3, the HTML Application is composed of several related display objects—screens, 20, views, 22, and applets, 24. These objects are shared across Application deployments (Dedicated and HTML). The HTML presentation of these display objects is controlled by a handful of reusable templates, 27, illustrated in FIGS. 4, 5, and 6. The templates, 27, define the Style and Structure of the HTML that is eventually generated by the web engine, as the Siebel Web Engine, in response to a request from the Web server. A template, 27, is an HTML File that contains references to display objects, for example, Siebel HTML display objects. As shown in FIG. 3, display objects are applets, 24, and Controls, depending on the type of template. Templates are very generic and not tied to specific applets/views. As shown in FIGS. 4 and 6, display objects are defined in the repository. Templates are stored in the file system, as shown in FIGS. 4 and 6. The mapping between applets/views and their respective templates is achieved visually in appropriate toolkits, as Siebel Tools.

The template file, as the Siebel template File (.HSWE), may be a combined description of the style, structure, and binding to the data via dedicated client display objects (applets, and views). The new approach, is a more modular one that separates style and structure (style sheets and templates) from the binding (HTML display objects) to data or content. Style and structure is reused across multiple HTML display objects. Thus, modifications to the Style and structure can be easily propagated to all HTML display objects. FIG. 3 shows the relationships between style sheets, templates, HTML display objects, business components and business objects, and the final HTML output.

The steps to create an applet web layout are described below. The steps for creating views are similar:

As shown in FIG. 5, the first step is to edit the (applet) template, 27, using an external HTML development tool such as Macromedia Dreamweaver, Microsoft FrontPage, etc. In this step, the structure and style of the template is edited so that it is consistent with the style of the remainder of the web site. The Style information is maintained in external Cascading style sheet files, as shown in FIG. 5. The elements in the template refer to the style defined in these external style sheets. The template contains references to Controls, 23, called Placeholders, as illustrated in FIG. 3. A repository definition of an applet contains a mapping from Controls, 23, to these placeholders in the template, 27. Similar applets, 24, are based on the same template, 21. This allows style and structural changes to be made to a small number of templates and propagated to all the applets that are based on them.

A new applet can be created based on a business component definition using the applet Wizard. The Wizard also allows the developer to specify the template to be used by the applet as well as the Fields to be made available in the web layout. In addition to Controls and List Columns, applets can also contain Web Controls which are controls that appear only in the Web layout.

Similarly, an existing applet can be made available over the web by selecting a template and then launching the applet Web Layout Editor to define the Web Layout of the applet.

A user can edit the applet Web Layout using the applet Web Layout Editor (AWLE). Each Control/List Column/Web Control is mapped to a placeholder in the template. The developer can drag Controls or List Columns from the standard layout of the applet onto the Web Layout. He/she can also drag and drop one control on top of another, causing the two controls to swap positions. New Web Controls can also be created and mapped to placeholders in the template. The AWLE does not support adding or deleting controls or editing the HTML in the template.

If at this point the developer feels like making changes to the HTML structure in the underlying template, he/she can invoke the external HTML Editor. For example, the List applet being created might require one more column than what is available in the template, 27. Another example of a modification may be necessitated by a global style change for the website. The steps of editing the applet web layout and making changes in the HTML structure may be iterated.

The repository changes are compiled into the repository file, as the Siebel Repository File (SRF). When the HTML Application is run, the server application, as the Siebel Web Engine, reads the applet definition from the SRF, selects the specified template, 27, combines the two, and retrieves the necessary data from the underlying business objects/business components, and presents the HTML output to the user. Views, 22, are created in a similar manner. The only difference is that view, 22, definitions contain applets, 24, and view templates contain applet Placeholders. Thus, in the view Web Layout Editor (VWLE), the developer drags and drops applets, 24, onto the Web layout of the view, 22. Given a template, 27, it is thus possible to generate an HTML display object, 25, completely from within a suitable tools application, as Siebel Tools.

The HTML Application is assembled from the various HTML display objects, 25, and templates, 27, that were shipped with the base application and those that were created using the eps described in the previous section. This is shown at a high level in FIG. 5.

The developer can use the Repository Validator, shown in FIG. 5, to detect errors in the configuration of the HTML Application and associated templates. This helps the developer detect invalid object references as well as verify that all required attributes of Controls and Web Controls have been specified. The Repository Validator will be enhanced to add new rules that pertain specifically to Application and HTML display objects.

The errors in the repository definition of the HTML Application are then fixed. Templates, 27, are further edited to accommodate changes to the changes in the HTML display object, 25, definitions, as well to fix missing and invalid links to external HTML files.

These steps are repeated periodically throughout the configuration process to ensure a correctly configured HTML Application, 67.

Once the HTML Application, 67, has been configured and tested, it is ready to be deployed. The HTML Application comprises of object definitions in the Repository as well as externally stored templates, style sheets, and other supporting files such as Images, Sound files, etc. Ta help deploy this entire Application and supporting files, tool kits, such as Siebel Tools, provide an ability to “Package” the HTML Application, 67. This may create a zip file containing all the support files required by the Application. This zip file is copied to the test or deployment area and unzipped into the appropriate directory structure.

The configured HTML Application, 67, can be upgraded to later releases of the server based application, as the Siebel Web Engine. A thin client application, such as a Siebel eApplication, is delivered as a set of templates, style sheets, and a repository containing the corresponding HTML display objects (Original Standard Repository). Customers take this HTML Application and configure the look and feel, business logic, and flow to fit their unique needs, and create a customized version of the HTML Application. It is important to provide customers with a consistent path to upgrade their customizations to future releases of that server application, such as, a Siebel eApplication. Exemplary is the Siebel Application Upgrader. The Siebel Application Upgrader generates a New Customized Repository by applying the customizations to the New Standard Repository.

The developer then uses the applet editor and view editor to make any modifications to the respective HTML display objects that were necessitated by the upgrade. Templates may need to be tweaked using external HTML editor in order to accommodate the changes that will be necessitated by the upgrade. The developer iterates through these steps until the HTML Application has been satisfactorily upgraded. The Validator, shown in FIG. 5, can be used to detect any errors in the HTML Application definition.

According to one application of the method and system of our invention, the customer already has a dedicated client application running on a server, which the customer has already configured and deployed, and now the customer wants to deploy some or all of the application as an HTML Thin Client. The HTML Thin Client Application must have the same look-and-feel as the rest of the customer website. In this case, there is, usually, a large body of Objects (views, applets, business components, business objects, etc.) That have already been configured. Some or all of them need to be converted into components of an HTML Thin Client Application. Firs), as a general rule, the business logic of the Application can be reused in the HTML Thin Client deployment without any modification. It is, thus, only necessary for the customer's Application developers to configure the look-and-feel of the application. This entails first making modifications to the templates shipped with the web-based applications to conform to the look of the rest of the website, as shown in FIGS. 4 and 5. For this, the developers use the HTML development environment of choice. Next, the developers create web layouts for the applets and views using templates. The developers then assemble the new HTML Application definition from the applets, views, and associated templates. This is iterative. Finally, the developers validate the HTML Application definition, checking for configuration errors.

In another embodiment of the method and system of our invention the customer may customize an application, as a web-based application, for example, to fit into their corporate website. The business logic of the standard application can be configured based on the customer's needs. The application developers then configure the look-and-feel of the application. This is accomplished by following the same steps as outlined above. The only difference is that new templates will need to be applied to existing applet and view definitions to obtain the appropriate look. For example, when a new version of an underlying, server-based, eCommerce application is delivered, the customized application must be upgraded. This involves following tasks: Upgrading the custom repository including applets, 24, BusComps, views, 22, HTML application object, etc. Upgrading the templates, 27, to accommodate the changes that will be necessitated by the upgrade. In most cases, using the equivalent customized templates will be sufficient. It is also necessary to review conflicts, to tweak applet and view definitions, to validate the HTML Application, and to test the upgraded application.

2. Templates

The server based web engine, as the Siebel Web Engine, combines an applet/view definition with its corresponding template, 27, to generate an intermediate (internal) representation that defines the data to be displayed and is in many ways equivalent to an HSWE template that is processed by the Siebel Web Engine in Siebel 99 or 99.5

As illustrated in FIG. 3, templates, 27, contain the overall layout information. They also contain placeholders for controls, 23, list columns, and applets, 24. The placeholders have an ID attribute, which will be used for the purposes of binding the placeholder to a control, list column, or applet.

Style Information includes References to external Cascading style sheets that contain style information.

The contents of an applet/view, 24 and 22, can only refer to Placeholders that exist in the template, as shown in FIGS. 4, 5, and 6. Hence, a template, 27, must contain enough placeholders to accommodate the maximum number of controls that an associated applet/view may contain. Alternatively, the template may use iterators are a convenient shorthand.

3. Creating Applets for Web Display

Applets, 24, can be created by either using the respective Wizard, or by using the Object Explorer and List Editor. Creation using the Object List Editor is the same as for all other Object Types. This Wizard facilitates the creation of the various different types of applets, such as form applets and list applets.

In a List applet Wizard the developer selects the Project, business component, Name, and Title for the applet, and then selects the Fields that will appear in the applet and orders them. Thereafter, the developer determines whether the applet is to be made available for web display. If so, the Base template to use, the Query template to use, and the Edit template to use.

If the user does not wish to make the applet available for web display, the final review page for the wizard is shown. The developer is presented with a screen asking him/her to choose the Fields that will be made available in that Web layout of the applet. The default choice in each case to make the Fields available in the standard layout to be available in the Web layout. This results in a default layout of the applet and its Web Layout using the template as a starting point. The developer can further modify the web layout using the Web Layout capabilities of the applet Editor.

Editing applet Web Layout. As shown in FIG. 4, the Web Layout view of the Web Editor allows developers to modify the web layout of the applet by updating the mapping between Controls and Web Controls in the applet and Placeholders in the template. The applet Editor supports a split view mode, where the Standard view and Web Layout view are available simultaneously as two panes stacked one above the other. The developer can drag a control from the standard view and drop it on a placeholder in the web view.

When the Web layout view of the applet, 24, is invoked, the template, 27, is displayed. Placeholders that have not been associated with a Control, 23, are highlighted. The gestures available to the developer in the Web Layout view include: selecting the Web Layout view, as Base Read-only, Query, Edit; specifying or changing the specified template; viewing the properties of the selected control, list column or web control in the properties window; editing the properties of the selected web control; dragging a control or list column from the standard view to a placeholder in the web layout view; dragging a web control from the web controls window and dropping it onto a placeholder; creating a new web control and associating it with a placeholder; selecting a placeholder and dissociating it from the associated control, list column, or web control.

Still other gestures include dismissing the web layout view; launching the template editor; previewing the applet web layout in an external browser; validating the applet definition; adding a control or HTML tag; removing a control or HTML tag; moving a control or HTML tag to an arbitrary position within the template.

To make these and other changes, the definition of the template needs to be edited in a template Editor or an external HTML development environment. Both editors are accessible from the applet Editor. The external HTML editor can be launched from the applet Editor. Its behavior is defined in the following section. The developer can preview the applet in a browser window. The list of Browsers available for preview is configured in the Preferences.

4. Editing a Template

As shown generally in FIG. 4, a template, 27, can be edited using an external HTML Development environment of choice. The developer can launch the external HTML editor from the applet Web Layout Editor or view Web Layout Editor. The user can also create a new template Definition and launch the external editor to edit the template.

5. Creating Views for Web Display

Views can be created by either using the view Wizard, or by using the Object Explorer and List Editor. Creation using the Object List Editor is the same as for all other Object Types. This section describes the creation using the Wizard.

View Wizard—This wizard takes the developer through the basic steps of the creating a section this section; selecting the business object that the view will be based on; and selecting the template to be used.

The view Layout Editor is launched and if a template was specified, the view Web Layout Editor (VWLE) is also launched.

Editing view Layout—The view Web Layout Editor (VWLE) allows developers to modify the Web layout of the views by mapping applets to Placeholders in the template being used for Web display. The template can be edited using the HTML development environment of the developer's choice. The applets Window is a floating Window that contains a list of all applets based on business components in the Business Object of the view.

The gestures available to the developer in the VWLE include: dragging an applet from the applets window and drop it onto an applet (placeholder) in the section editor; selecting a placeholder; viewing the attributes of Siebel applets using the properties window; launching the external HTML editor to edit the underlying template; validating the view definition; dropping an applet from the web layout of the view; adding an HTML tag; removing an HTML tag; and moving an applet to an arbitrary position within the template.

To make these and other changes, the definition of the template may be edited in the external HTML development environment. The external HTML editor can be launched from the VWLE.

The developer can preview the view in a browser window.

6. Validating an HTML Application

As shown in FIG. 5, there are two levels of validation that need to be supported: validating selected applets/views, and validating the entire application. The rules to be enforced include:

Detecting Invalid Object References. This is a generic rule that can be applied to Application and applets/views, and Web Pages. This will help the developer detect errors such as dead links, references to illegal Fields in applets, etc.

Applet/view is out of date. If an applet/view definition is older than the definition of the corresponding template definition, then the applet/view needs to be checked to ensure that there are no references to non-existent Placeholders.

7. Upgrading an HTML Application

An HTML Application is normally delivered as a set of templates and the repository object definitions of the BusComps, BusObjects, Application, applets, views, Web Pages, etc. The upgrade process involves the following major steps: (1) Upgrading the Custom Repository including BusComps, BusObjects, HTML application object, applets, views, etc. (2) Tweaking the templates to accommodate the changes necessitated by the repository upgrade. (3) Tweaking the applet and view definitions if necessary. (4) Validating the upgraded Application. (5) Testing the upgraded application.

Each of these steps are described in detail below:

Upgrading the templates. The developer first identifies equivalent templates, 27 in the Custom and New Standard Application. Templates that are used by template Objects with the same name are considered “equivalent”. Another test of equivalency is to identify those templates that are used by a similar group of template Objects e.g., List, Read-only Form, Entry, etc.

Once equivalent templates have been identified, they are compared. In general, the templates in the Custom application will have a different look and feel in terms of style. The developer then modifies the templates in the custom application to accommodate modifications that may be necessitated when the template objects are upgraded.

Examples of such modifications include, by way of example, adding control placeholders, adding new tags that did not appear in the prior versions, and additional arguments/a ‘butes for existing controls and methods that are supported by the new web engine.

Upgrading the Repository. The developer then upgrades the Repository using an HTML editor or an Application Upgrader wizard. This upgrades not just the HTML Application but also all the Objects in the repository. As a result of the upgrade, some objects are added to the repository, some are deleted, and many are modified.

Reviewing conflicts. The developer reviews conflicts encountered during the upgrade process and makes certain that they have been satisfactorily resolved. If the default resolution is not the desired one, it is overridden. The default conflict resolution for applet, view, and Application objects is “Custom Wins”, i.e., the custom value of the conflicting attribute is used by default in case of a conflict. Conflicts in the “applet Web template Item” object definitions are resolved using the Custom Wins flag. The Name of each Object definition is the same as the Identifier within the Placeholder. Each placeholder is mapped to one and only Control or Web Control.

Validating the repository. The developer then runs the Repository validator to identify and fix invalid object references and other violations that may have been caused by the upgrade.

Compiling and testing the dedicated Application. The developer compiles the repository. He/she then runs the dedicated client application. Certain object definitions may need further modification in order for the dedicated client application to work as desired. Once this is complete, the developer is now ready to review and modify the HTML Application.

Editing applets and views using the appropriate Editor. The developer opens each applet/view Object in the appropriate Editor. He/she then resolves any incomplete or invalid Placeholder references. There may be Controls/applets added in the upgrade process that refer to ids that are not present in the template. In this case, these Controls/applets are moved into “valid” ids i.e., their ID attribute is updated to point to a valid placeholder.

The applet may be previewed in the Web Preview Mode.

While the invention has been described with respect to certain exemplifications and embodiments, it is not intended to limit the scope of the invention thereby, but solely by the claims appended hereto.

We claim:

1. A system residing on one or more computers including a server for a thin client client-server system, said system configured when executed to:
(a) define page models from stored style sheets and templates;
(b) build and configure display objects including applets and views in a page delivery language, said display objects being stored separately from said style sheets and templates; and
(c) assemble the display objects into a page delivery language application.

2. The system of claim 1 wherein the models to be defined are pages.

3. The system of claim 1 wherein the page delivery language is chosen from the group consisting of HTML, XML, DHTML, and WML.

4. The system of claim 1 the display objects are chosen from the group consisting of applets and views.

5. The system of claim 1 wherein the display objects are assembled from templates.

6. The system of claim 5 wherein the system is configured to edit display object templates.

7. The system of claim 1 wherein the system is configured to reuse style sheets and templates across display objects.

8. A method of serving page delivery language display objects to a thin client in a client-server system, comprising:
(a) defining page models from stored style sheets and templates;
(b) building and configuring display objects including applets and views in the page delivery language and storing said display objects separately from said style sheets and templates; and
(c) assembling the display objects into a page delivery language application.

9. The method of claim 8 wherein the models to be defined are pages.

10. The method of claim 8 wherein the page delivery language is chosen from the group consisting of HTML, XML, DHTML, and WML.

11. The method of claim 8 the display objects are chosen from the group consisting of applets and views.

12. The method of claim 8 comprising assembling the display objects from templates.

13. The method of claim 12 comprising editing the display object templates.

14. The method of claim 8 comprising reusing style sheets and templates across display objects.
